(19) United States
(12) Patent Application Publication
(10) Pub. No.: US 2011/0093741 A1
(43) Pub. Date: Apr. 21, 2011

(54) METHOD FOR RECOVERING BIOS AND COMPUTER SYSTEM THEREOF

(76) Inventors: Te-Yu Liang, Taipei Hsien (TW); Cheng-Te Chen, Taipei Hsien (TW); Wen-Chun Tsao, Taipei Hsien (TW); Szu-Wei Pan, Taipei Hsien (TW)

(21) Appl. No.: 12/764,085

(22) Filed: Apr. 20, 2010

(30) Foreign Application Priority Data
Oct. 15, 2009 (TW) 098134935

(51) Int. Cl. G06F 11/08; G06F 1/00; G06F 11/00

(52) U.S. Cl. 714/6.1; 713/300; 714/E11.03

(57) ABSTRACT

A method for recovering basic input/output system (BIOS) in a computer system is disclosed. The computer system includes a host unit, a control unit, and a first storage device. The control unit is utilized for controlling system power provided for the host unit. The host unit is utilized for accessing a BIOS code stored in the first storage device to perform a boot process. The method includes turning the system power off when the computer system has a recovery requirement, restoring a backup BIOS code into the first storage device, and turning the system power on to make the host unit access the restored BIOS code in the first storage device for performing the boot process.

### BACKGROUND OF THE INVENTION

1. Field of the Invention

The present invention relates to a method for recovering BIOS and a computer system thereof, and more particularly, to a method capable of utilizing a control unit to control a recovery process and the computer system thereof.

2. Description of the Prior Art

A basic input/output system (BIOS) plays a very important role in the functioning of a computer during boot-up. In general, from the time a user presses a power-on button to the time the computer system has completed loading the OS, the BIOS performs various processes in succession, such as a power on self test (POST), hardware initialization, default settings record of the computer system, providing runtime programs, or loading the operating system (OS). Thus, through the BIOS, hardware configurations of all components can be initialized and the computer system can load the OS successfully during boot-up. BIOS code is usually stored in a storage device in practice. As the computer system provides system power to a CPU, the CPU further accesses and executes the BIOS code stored in the storage device in order to perform a boot process for the computer system.

However, since the BIOS code stored in the storage device may be corrupted or incomplete, and therefore nonfunctional, due to physical damage or other factors, the CPU will not be able to execute a complete BIOS code for performing the boot process, resulting in a boot failure. To prevent the boot failure when the BIOS code is broke, the prior art utilizes several storage devices for storing several backup BIOS codes and sets priority orders for accessing the backup BIOS codes. Therefore, the prior art is able to selectively access other backup BIOS codes stored in other storage devices when the BIOS code is broken. Although the prior art can resolve the boot failure problem by using the above method, this results in increased manufacturing cost. Therefore, the prior art further proposes another method. Please refer to FIG. 1, which is a schematic diagram of a computer system 10 according to the prior art. The computer system 10 includes a host unit 102, a primary storage device 104, and a backup storage device 106. The primary storage device 104 is utilized for storing a BIOS code. The backup storage device 106 is utilized for storing a test program and a backup BIOS code. During a boot process, the host unit 102 accesses and executes the test program to check if an error has occurred. If no error has occurred, the host unit 102 further accesses and executes the BIOS code to perform a boot process. If an error has occurred, the backup BIOS code stored in the backup storage device 106 will be copied to the primary storage device 104. Again, the host unit 102 further accesses and executes the copied BIOS code in the primary storage device 104 to perform the boot process. However, such a dual BIOS scheme requires storage space which is more than twice that needed for the BIOS code for establishing the backup scheme. In addition, as the test program of the backup storage device 106 is broken, the host unit 102 cannot accomplish the check procedure, and the host unit 102 is further unable to complete the boot process.

### SUMMARY OF THE INVENTION

It is therefore an objective of the invention to provide a method for recovering basic input/output system (BIOS) and a computer system thereof.

An embodiment of the invention discloses a method for recovering a BIOS in a computer system, the computer system comprising a host unit, a control unit, and a first storage device, the control unit for controlling system power provided to the host unit, the host unit for accessing a BIOS code stored in the first storage device via a first data transmission unit to perform a boot process, the method comprising the steps of: turning the system power off when the computer system has a recovery requirement; restoring a backup BIOS code into the first storage device; and turning the system power on to make the host unit access the restored BIOS code in the first storage device for performing the boot process.

An embodiment of the invention further discloses a computer system which comprises a first storage device, for storing a BIOS code; a second storage device, for storing a control code and a backup BIOS code; a host unit, coupled to the first storage device via a first data transmission unit, for accessing the BIOS code to perform a boot process; and a control unit, coupled to the host unit, for controlling system power provided to the host unit according to the control code; wherein when the computer system has a recovery requirement, the control unit controls the system power to be turned off and controls the backup BIOS code to be restored into the first storage device, and controls the system power to be turned on to make the host unit access the restored BIOS code in the first storage device for performing the boot process.

An embodiment of the invention further discloses a method for recovering a BIOS in a computer system, the computer system comprising a host unit, a control unit, and a first storage device, the control unit for controlling system power provided to the host unit, the host unit for accessing a BIOS code stored in the first storage device via a first data transmission unit to perform a boot process, the method comprising the steps of: utilizing the control unit to turn the system power off when the computer system has a recovery requirement; utilizing the control unit to control the host unit to access data and turn the system power on; utilizing the host unit to access a BIOS boot block code stored in a second storage device; utilizing the host unit to execute the BIOS boot block code to restore a backup BIOS code stored in a third storage device into the first storage device; utilizing the control unit to turn the system power off; and utilizing the control unit to turn the system power on to make the host unit access the restored BIOS code in the first storage device via the first data transmission unit for performing the boot process.

An embodiment of the invention further discloses a computer system which comprises: a first storage device, for storing a BIOS code; a second storage device, for storing a control code and a BIOS boot block code; a third storage device, for storing a backup BIOS code; a host unit, coupled to the first storage device via a first data transmission unit, for accessing the BIOS code to perform a boot process; and a control unit, coupled to the host unit, for controlling system power provided to the host unit according to the control code; when the computer system has a recovery requirement, the host unit accesses the BIOS boot block code, restores the backup BIOS code stored in the third storage device into the first storage device after executing the BIOS boot block code, and accesses the restored BIOS code of the first storage device for a boot process.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a computer system according to the prior art.

FIG. 2 is a schematic diagram of a computer system according to an embodiment of the invention.

FIG. 3 is a procedure for recovering the BIOS code of the computer system according to an embodiment of the invention.

FIG. 4 and FIG. 5 are schematic diagrams of performing BIOS recovery of the computer system shown in FIG. 2 according to an embodiment of the invention.

FIG. 6 to FIG. 8 are schematic diagrams of performing BIOS recovery of the computer system shown in FIG. 2 according to an embodiment of the invention.

FIG. 9 is a schematic diagram of a computer system according to an embodiment of the invention.

FIG. 10 is a procedure for recovering the BIOS code of the computer system according to an embodiment of the invention.

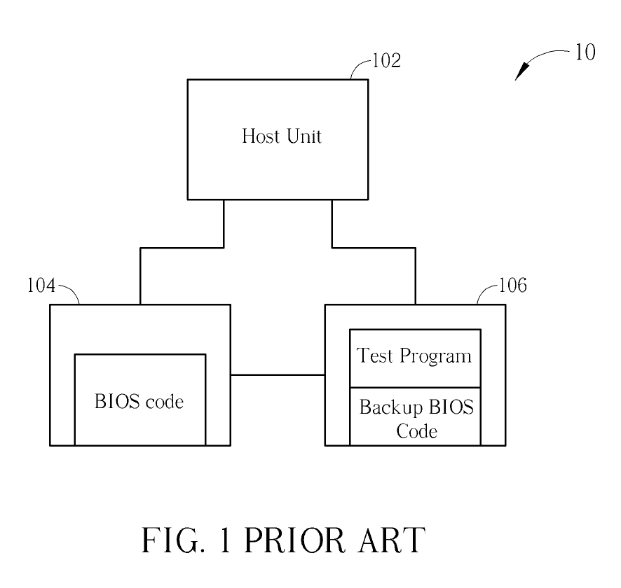

### DETAILED DESCRIPTION

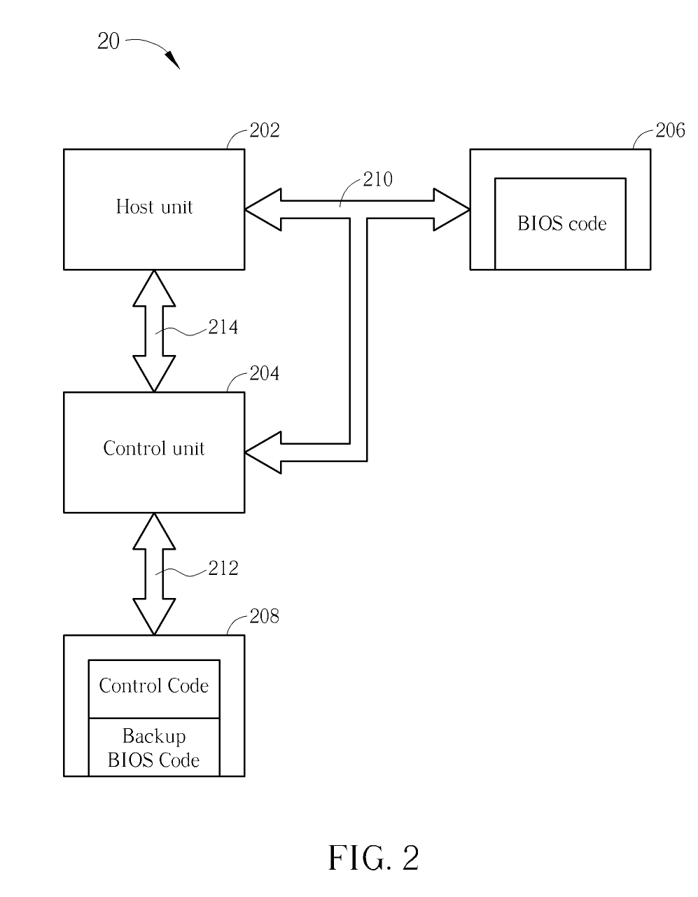

Please refer to FIG. 2, which is a schematic diagram of a computer system 20 according to an embodiment of the invention. The computer system 20 includes a host unit 202, a control unit 204, a first storage device 206, a second storage device 208, a first data transmission unit 210, a second data transmission unit 212, and a third data transmission unit 214. The first storage device 206 is utilized for storing a BIOS code. The second storage device 208 is utilized for storing a control code, such as an embedded control code or other code with similar function, and a backup BIOS code. The host unit 202 is coupled to the first storage device 206 via the first data transmission unit 210 to access and execute the BIOS code during a normal boot process. The control unit 204 is respectively coupled to the first storage device 206, the second storage device 208, and the host unit 202 via the first data transmission unit 210, the second data transmission unit 212, and the third data transmission unit 214. The control unit 204 is capable of controlling electrical power provided for each element of the computer system 20, such as system power for the host unit 202, and controlling a BIOS recovery process according to the control code.

As stated in the prior art, since the BIOS code stored in the first storage device 206 is corrupt or incomplete due to suffering physical damage, and therefore nonfunctional, the host unit 202 will fail to execute the complete BIOS code for performing a boot process. In such a condition, the conventional technique must utilize the host unit 202 equipped with a required system power supply to check the above-mentioned error situation and perform a BIOS recovery process. That is, in the prior art, the host unit 202 cannot accomplish the BIOS recovery process without required system power. Comparatively, the embodiment of the invention can utilize the control unit 204 to check an error state of the BIOS code without being supplied the system power and may further control the recovery process and the on/off operation of the system power for recovering the BIOS code when the computer system has a BIOS recovery requirement. Accordingly, the embodiment of the invention can also prevent a boot failure situation that may happen due to the corrupted test program stored in another storage device. Regarding the detailed operations of the computer system 20, please refer to the following statements.

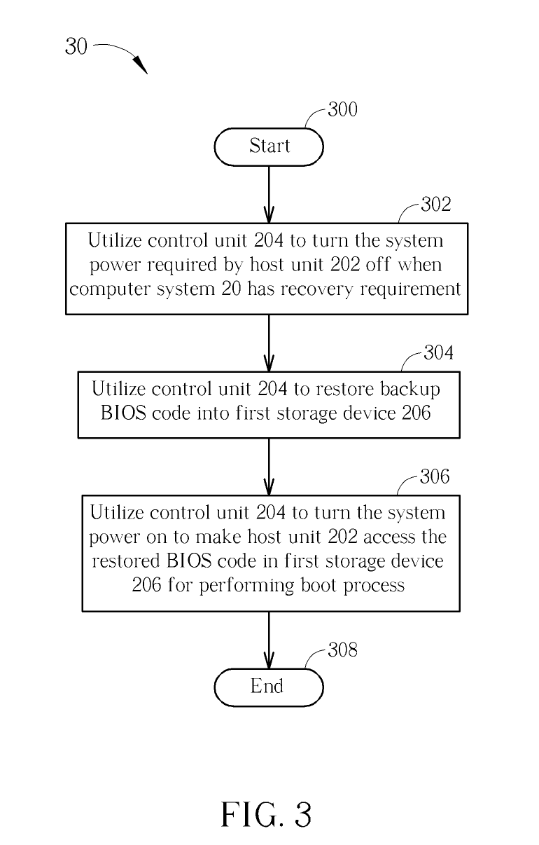

Please refer to FIG. 3, which is a procedure 30 for recovering the BIOS code of the computer system 20 according to an embodiment of the invention. The procedure 30 is utilized for realizing an operation procedure for the computer system 20. The procedure 30 includes the following steps:

Step 300: Start.

Step 302: Utilize control unit 204 to turn the system power required by host unit 202 off when computer system 20 has recovery requirement.

Step 304: Utilize control unit 204 to restore backup BIOS code into first storage device 206.

Step 306: Utilize control unit 204 to turn the system power on to make host unit 202 access the restored BIOS code in first storage device 206 for performing boot process.

Step 308: End.

According to the procedure 30, the computer system 20 can realize the BIOS recovery process through the control operation of the control unit 204. In Step 302, when the computer system 20 has a recovery requirement, such as when a corrupted BIOS code stored in the first storage device 206 is checked or a recovery hot key is pressed, the system power supplied to the host unit 202 is turned off by the control unit 204. In this situation, the host unit 202 stops accessing the BIOS code from the first storage device 206, and the computer system 20 enters a recovery process state. Note that, in the embodiment of the invention, any method or scheme used for indicating that the computer system 20 has a recovery requirement to the control unit 204 is suitable. For example, in the embodiment of the invention, when a hot key(s), a combination key(s), or a specific button(s) is (are) pressed, a recovery requirement is triggered to the control unit 204. The combination key can be a combination of various keys. The specific button can be a recovery starting button. Therefore, the control unit 204 is capable of turning the system power provided for the host unit 202 off according to the triggered recovery requirement. Optionally, the control unit 204 can determine whether the computer system 20 has a recovery requirement or not by observing operation status of routine procedures. For example, in a normal computer system, the control unit 204 will receive a notification after a successful boot process is completed. In other words, the control unit 204 can examine whether the successful boot notification is transmitted after the power-on button is pressed. If no successful boot notification is transmitted within a specific duration, the control unit 204 determines that a boot failure occurs. In such a condition, when the control unit 204 checks the number of boot failures occurring in the computer system 20 is greater than a threshold value (ex. three times), the control unit 204 is able to turn the system power off, and the procedure goes to Step 304 to Step 308. In addition, the control unit 204 can also check whether the computer system 20 has a recovery requirement through considering the status of any connection port, such as the status of port 80. For example, when the control unit 204 checks that the number of accumulated boot failures generated by the port 80 is greater than a threshold value (ex. five times), the control unit 204 can turn the system power off, and further perform the BIOS recovery procedure.

Besides, in Step 304, the control unit 204 can further check whether an error occurs in the BIOS code of the first storage device 206 and restore the backup BIOS code stored in the second storage device 208 into the first storage device 206 when the error occurrence of the BIOS happens. Preferably, when no error occurrence exists in the BIOS code, the control unit 204 need not perform the process of restoring the backup BIOS code into the first storage device 206, and the procedure goes to Step 308. On the other hand, the control unit 204 can employ any error check technique. For example, the control unit 204 can perform a checksum process, a parity check process, or acyclic redundancy check process on the BIOS code stored in the first storage device 206 in order to check the BIOS error status.

In Step 306, since the control unit 204 has restored the backup BIOS code into the first storage device 206, the control unit 204 controls the system power to be re-turned on to provide power to the host unit 202. In such a condition, the host unit 202 can further access the restored BIOS code stored in the first storage device 206 to perform the boot process successfully.

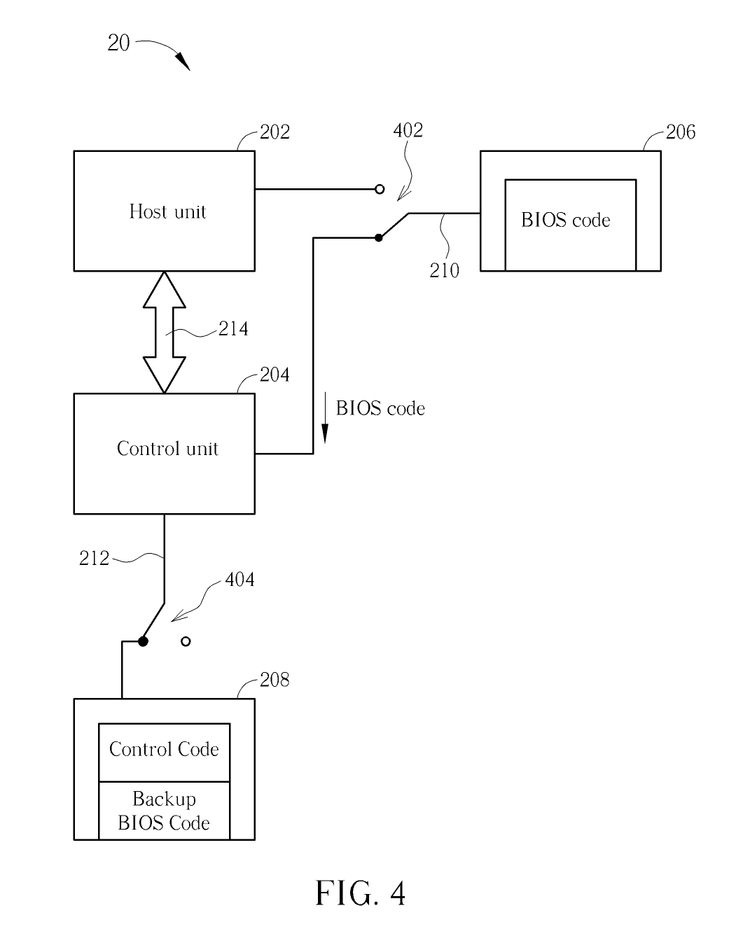

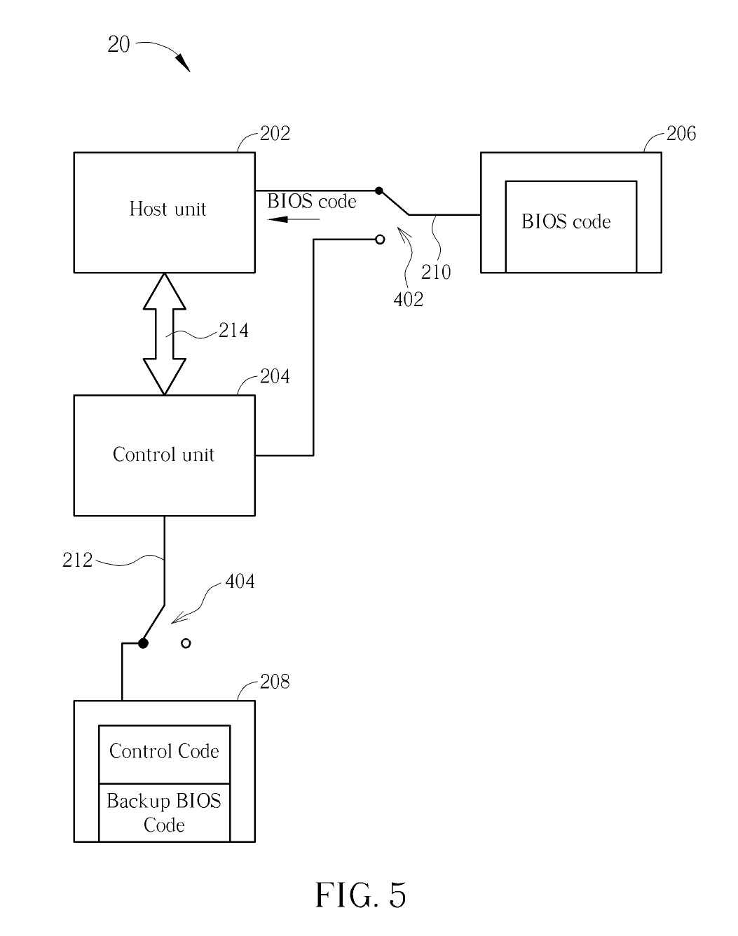

Please refer to FIG. 4 and FIG. 5, which are schematic diagrams of performing BIOS recovery in the computer system 20 shown in FIG. 2 according to an embodiment of the invention. As shown in FIG. 4, when the computer system 20 has a recovery requirement, the control unit 204 turns the system power provided to the host unit 202 off, so that the host unit 202 stops accessing the BIOS code from the first storage device 206. Thus, the control unit 204 checks the BIOS code stored in the first storage device 206 via the first data transmission unit 210 to determine if an error occurrence (corrupt or incomplete code) exists in the BIOS code or not. If yes, i.e. the error occurrence exists in the BIOS code, the control unit 204 first reads the backup BIOS code stored in the second storage device 208 via the second data transmission unit 212. After that, the control unit 204 transmits the read backup BIOS code to the first storage device 206 via the first data transmission unit 210 and restores the read backup BIOS code into the first storage device 206. In detail, the original BIOS code stored in the first storage device 206 has been replaced by the read backup BIOS code which is a perfect BIOS code. Therefore, as shown in FIG. 5, the control unit 204 controls the first data transmission unit 210 to switch to connect between the host unit 202 and the first storage device 206 and turns the system power on for the host unit 202, so that the host unit 202 is able to access and execute the recovered BIOS stored in the first storage device 206 via the first data transmission unit 210 for performing the boot process successfully.

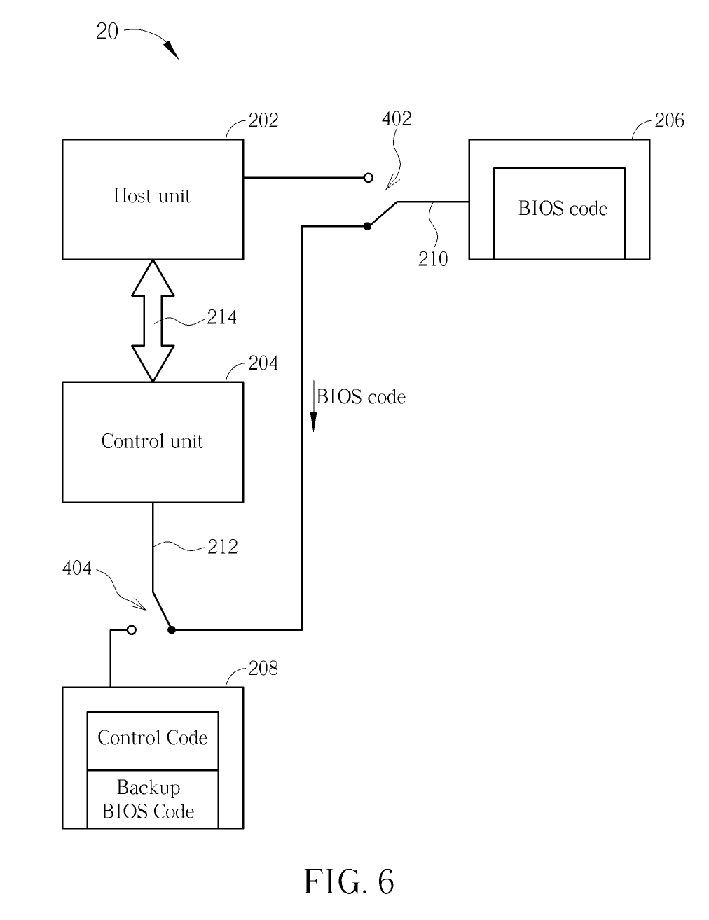

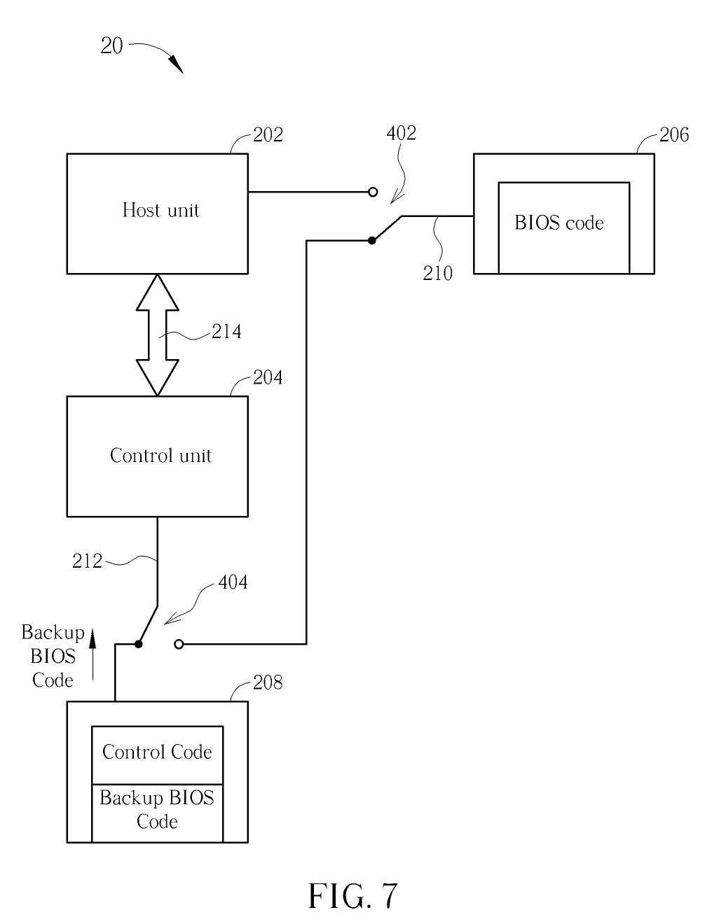

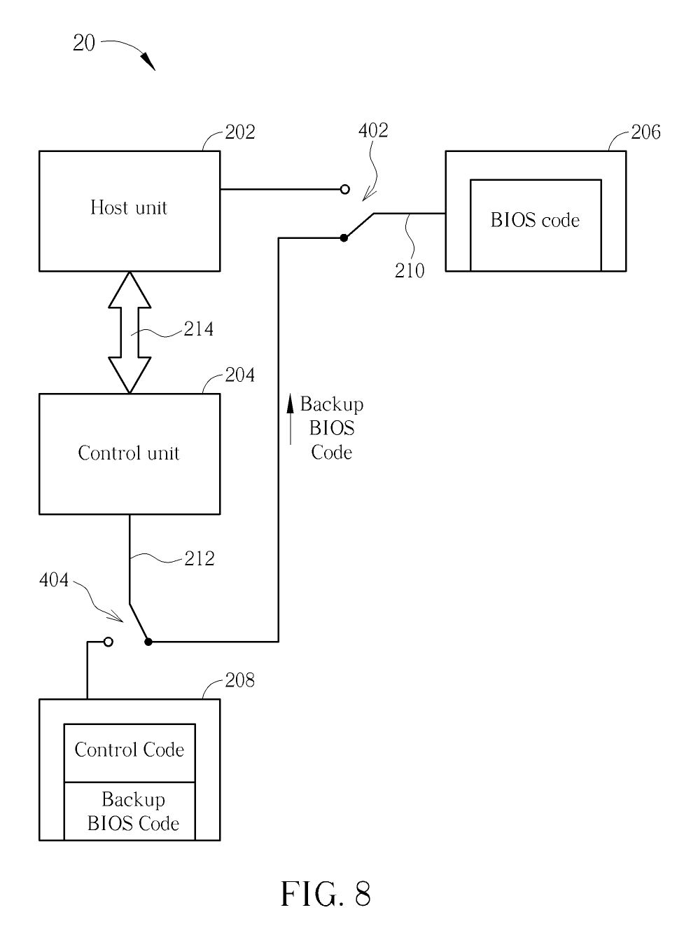

In addition, when the control unit 204 cannot support sufficient input/output ports during the recovery process, please refer to FIG. 6 to FIG. 8, which are schematic diagrams of performing BIOS recovery in the computer system 20 shown in FIG. 2 according to an embodiment of the invention. As shown in FIG. 6, when the computer system 20 has a recovery requirement, the control unit 204 turns the system power provided to the host unit 202 off. The control unit 204 can control the first data transmission unit 210 and the second data transmission unit 212 so as to check the BIOS code stored in the first storage device 206 via the first data transmission unit 210 and the second data transmission unit 212. As shown in FIG. 7, when an error occurrence in the BIOS code is checked, the control unit 204 switches the second data transmission unit 212 in order to read the backup BIOS code stored in the second storage device 208 via the second data transmission unit 212. After that, as shown in FIG. 8, the control unit 204 transmits the read backup BIOS code to the first storage device 206 via the first data transmission unit 210 and the second data transmission unit 212 after switching the second data transmission unit 212. The control unit 204 further restores the read backup BIOS code into the first storage device 206. Finally, the control unit 204 switches the first data transmission unit 210 to connect between the host unit 202 and the first storage device 206 and turns the system power on, and therefore the host unit 202 can access and execute the recovered BIOS stored in the first storage device 206 via the first data transmission unit 210 for realizing the boot process.

Preferably, as shown in FIG. 4 to FIG. 8, the first data transmission unit 210 includes a first switch 402. The first switch 402 can be selectively coupled to the host unit 202, the control unit 204, or the second transmission unit 212. Furthermore, the second data transmission unit 212 includes a second switch 404. The second switch 404 can be selectively coupled to the first transmission unit 210, or the second storage device 208. Note that, the first switch 402 and the second switch 404 can be implemented by transistors or other elements which can achieve a similar switching function.

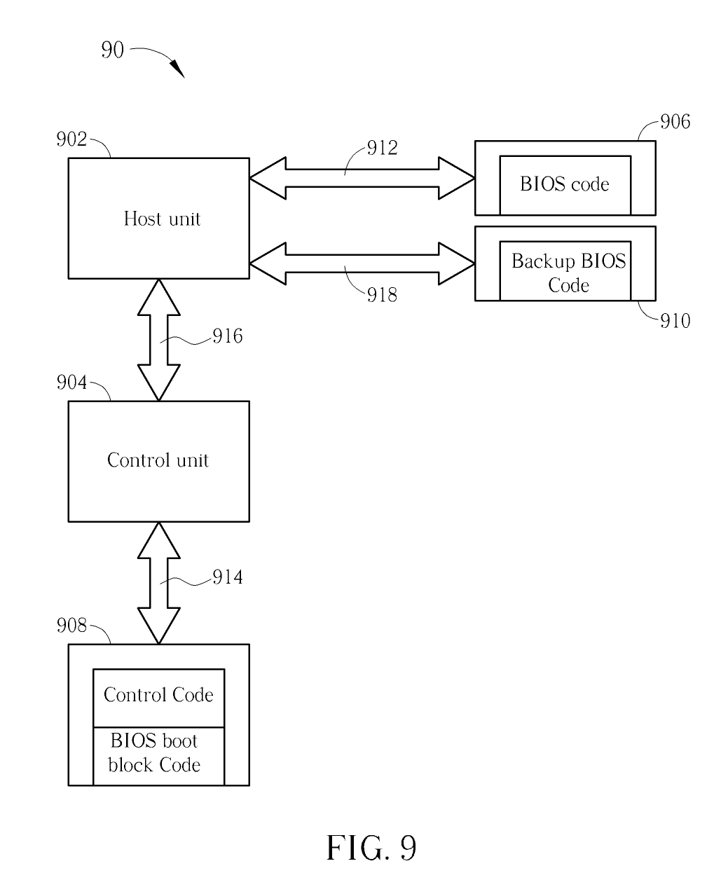

Please refer to FIG. 9, which is a schematic diagram of a computer system 90 according to an embodiment of the invention. Please note that elements of the computer system 90 shown in FIG. 9 with the same reference numerals as those in the computer system 20 shown in FIG. 2 have similar operations and functions and further description thereof is omitted for brevity. The connections of the units are as shown in FIG. 9. The computer system 90 includes a host unit 902, a control unit 904, a first storage device 906, a second storage device 908, a third storage device 910, a first data transmission unit 912, a second data transmission unit 914, a third data transmission unit 916, and a fourth data transmission unit 918. Different from the computer system 20 shown in FIG. 2 is that the second storage device 908 shown in FIG. 9 is utilized for storing the control code and a BIOS boot block code, the third storage device 910 shown in FIG. 9 is utilized for storing the backup BIOS code, and the host unit 902 is capable of accessing the backup BIOS code via the fourth data transmission unit 918. Preferably, the third storage device 910 can be an external storage device. When the computer system 90 has a recovery requirement, the control unit 904 can read the BIOS boot block code from the second storage device 908, and configure certain pins of the host unit 902 so that the host unit 902 can access the read BIOS boot block code from the control unit 904 via the second data transmission unit 914 and the configured pins and further execute the read BIOS boot block code accordingly. For example, the control unit 904 can configure a strap pin of the host unit 902, so that the host unit 902 is able to access the read BIOS boot block code from the control unit 904 via the strap pin and the second data transmission unit 914, which is not a limitation of the invention, as any other hardware or software design which can activate the host unit to access and execute the BIOS boot block code is suitable. After the host unit 902 executes the BIOS boot block code, the host unit 902 can restore the backup BIOS code stored in the third storage device 910 into the first storage device 906 correspondingly. As to the detailed operations of the computer system 90, please refer to the following statements.

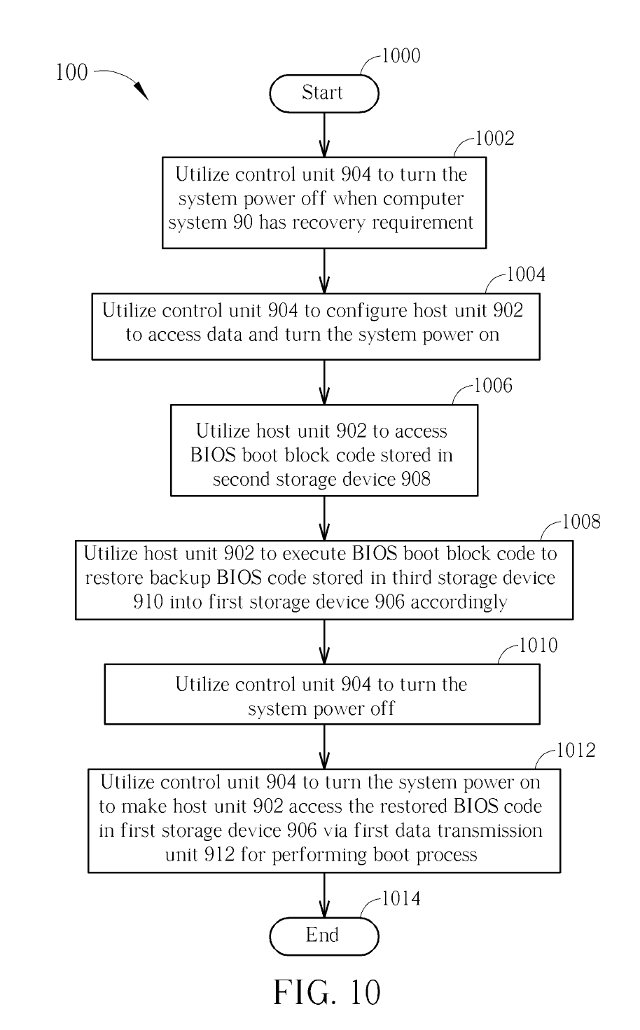

Please refer to FIG. 10, which is a procedure 100 for recovering the BIOS code of the computer system 90 according to an embodiment of the invention. The procedure 100 is utilized for realizing an operation procedure for the computer system 90. The procedure 100 includes the following steps:

Step 1000: Start.

Step 1002: Utilize control unit 904 to turn the system power off when computer system 90 has recovery requirement.

Step 1004: Utilize control unit 904 to configure host unit 902 to access data and turn the system power on.

Step 1006: Utilize host unit 902 to access BIOS boot block code stored in second storage device 908.

Step 1008: Utilize host unit 902 to execute BIOS boot block code to restore backup BIOS code stored in third storage device 910 into first storage device 906 accordingly.

Step 1010: Utilize control unit 904 to turn the system power off.

Step 1012: Utilize control unit 904 to turn the system power on to make host unit 902 access the restored BIOS code in first storage device 906 via first data transmission unit 912 for performing boot process.

Step 1014: End.

Furthermore, in Step 1002, when the computer system 90 has a recovery requirement, the computer system 90 utilizes the control unit 904 to turn the system power supplied to the host unit 902 off, so that the host unit 902 stops accessing the BIOS code from the first storage device 906. In general, the host unit 902 can access the external data via the first data transmission unit 912 or the second data transmission unit 914 by configuring the strap pin. In Step 1004, the control unit 904 can configure the strap pin and returns the system power, so that the host unit 902 can access data from the control unit 904 via the second data transmission unit 914. In Step 1006, the host unit 902 transmits an access request to the control unit 904 via the third data transmission unit 916, and the control unit 904 reads the BIOS boot block code from the second storage device 908 according to the access request. After that, the host unit 902 can access the BIOS boot block code read by the control unit 904 via the third data transmission unit 916. In Step 1008, the host unit 902 can read the backup BIOS code stored in the third storage device 910 via the fourth data transmission unit 918 and restore the read backup BIOS code into the first storage device 906 via the first data transmission unit 912 accordingly after the host unit 902 executes the BIOS boot block code. In Step 1010, the computer system 90 utilizes the control unit 904 to turn the system power off and configure the strap pin so that the host unit 902 can access the BIOS code from the first storage device 906 via the first data transmission unit 912 in the normal boot process. Finally, the computer system 90 utilizes the control unit 904 to turn the system power on and the host unit 902 can further perform the boot process with the recovered BIOS code. Therefore, compared with the prior art, the invention can utilize the control unit 908 to control the recovery process to avoid the boot failure situation that happens due to the corrupted test program, and the invention requires fewer storage devices (ex. second storage device 908) for storing the BIOS boot block code.

Note that, the computer systems 20 and 90 are exemplary embodiments of the invention, and those skilled in the art can make alternations and modifications accordingly. For example, the host unit 202 and 902 can be a CPU, a chipset (northbridge chip, southbridge chip), or any combination thereof, and this should not be a limitation of invention. The control unit 204 and 904 can be an embedded controller, a keyboard controller, a microprocessor, an I/O controller, or any other similar element having the same function. The above-mentioned storage devices 206, 208, 906, 908, and 910 can be any kind and any type of storage apparatus, such as read only memories (ROMs), flash memories, electrically erasable programmable read only memories (EEPROM), non-volatile memories, etc. The above-mentioned data transmission unit 210, 212, 214, 912, 914, 916, and 918 can be any kind of data transmission unit. For example, the first data transmission unit 912 and/or the second data transmission unit 914 can be implemented with a serial peripheral interface (SPI), the third data transmission unit 916 can be implemented with a low pin count (LPC) interface, the fourth data transmission unit 918 can be implemented with a universal serial bus (USB) interface, and those should not be a limitation of the invention. Besides, the mentioned hot key comprises one or more keys. For example, a function key Fn, a character key J, and a switch key as a default hot key, may be set so that when the three keys are pressed simultaneously, a recovery requirement is triggered correspondingly. The mentioned specific button can be any type of button, such as an existing button or an extra physical button of the computer system.

In summary, compared with the prior art, the invention need not check the situation of the BIOS code on each booting process. The invention can utilize the control unit to control the recovery process when the computer system has a recovery requirement and also avoid the boot failure situation that happens due to the corrupted test program. On the other hand, the invention requires fewer storage devices for storing the BIOS boot block code, so that the manufacturing cost is reduced accordingly.

Those skilled in the art will readily observe that numerous modifications and alterations of the device and method may be made while retaining the teachings of the invention.

What is claimed is:

1. A method for recovering a basic input/output system (BIOS) in a computer system, the computer system comprising a host unit, a control unit, and a first storage device, the control unit for controlling system power provided to the host unit, the host unit for accessing a BIOS code stored in the first storage device via a first data transmission unit to perform a boot process, the method comprising the steps of:
turning the system power off when the computer system has a recovery requirement;
restoring a backup BIOS code into the first storage device; and
turning the system power on to make the host unit access the restored BIOS code in the first storage device for performing the boot process.

2. The method of claim 1, wherein the step of turning the system power off when the computer system has the recovery requirement comprises:
turning the system power off when at least one hot key, at least one combination key, or at least one specific button is pressed, or when the control unit checks a number of boot failure occurrences of the computer system is greater than a threshold value.

3. The method of claim 1, wherein the step of restoring the backup BIOS code into the first storage device comprises:
checking the BIOS code stored in the first storage device; and
restoring the backup BIOS code into the first storage device when an error has occurred in the BIOS code.

4. The method of claim 3, wherein the step of checking the BIOS code stored in the first storage device comprises:
switching the first data transmission unit to connect the first storage device and the control unit; and
utilizing the control unit to check the BIOS code stored in the first storage device.

5. The method of claim 3, wherein the step of restoring the backup BIOS code into the first storage device when the error has occurred in the BIOS code comprises:
reading the backup BIOS code stored in a second storage device via a second data transmission unit when the error has occurred in the BIOS code; and
restoring the read backup BIOS code into the first storage device via the first data transmission unit.

6. The method of claim 3, wherein the step of checking the BIOS code stored in the first storage device comprises:
switching the first data transmission unit and a second data transmission unit to connect the first storage device and the control unit; and
utilizing the control unit to check the BIOS code stored in the first storage device.

7. The method of claim 6, wherein the step of restoring the backup BIOS code into the first storage device when the error has occurred in the BIOS code comprises:
switching the second data transmission unit so that the backup BIOS code stored in a second storage device are read by the control unit via the second data transmission unit when the error has occurred in the BIOS code; and
switching the second data transmission unit so that the read backup BIOS code are restored into the first storage device by the control unit via the first data transmission unit and the second data transmission unit; and
switching the first data transmission unit to connect the first storage device and the host unit, and switching the second data transmission unit to connect the second storage device and the control unit.

8. The method of claim 3, wherein the step of checking the BIOS code stored in the first storage device comprises:
performing a checksum procedure, a parity check procedure, or a cyclic redundancy check procedure on the BIOS code to identify whether the error exists.

9. A computer system, comprising:
a first storage device, for storing a BIOS code;
a second storage device, for storing a control code and a backup BIOS code;
a host unit, coupled to the first storage device via a first data transmission unit, for accessing the BIOS code to perform a boot process; and
a control unit, coupled to the host unit, for controlling system power provided to the host unit according to the control code;
wherein when the computer system has a recovery requirement, the control unit controls the system power to be turned off and controls the backup BIOS code to be restored into the first storage device, and controls the system power to be turned on to make the host unit access the restored BIOS code in the first storage device for performing the boot process.

10. The computer system of claim 9 further comprising at least one hot key, at least one combination key, or at least one specific button, wherein when the at least one hot key, the at least one combination key, or the at least one specific button is pressed, the recovery requirement is triggered so that the control unit controls the system power to be turned off according to the recovery requirement.

11. The computer system of claim 9, wherein when the control unit checks a number of boot failure occurrences of the computer system is greater than a threshold value, the control unit turns the system power off.

12. The computer system of claim 9, wherein the control unit switches a second data transmission unit to read the backup BIOS code via the second data transmission unit after the system power is turned off, and switches the first data transmission unit to restore the read backup BIOS code into the first storage device via the first data transmission unit.

13. The computer system of claim 12, wherein the control unit switches the first data transmission unit to check the BIOS code of the first storage device after the system power is turned off, reads the backup code stored in the second storage device when an error has occurred in the BIOS code, and restores the read backup BIOS code into the first storage device.

14. The computer system of claim 12, wherein the control unit switches the first data transmission unit to connect the first storage device and the host unit after the backup BIOS code is restored into the first storage device, and turns the system power on.

15. The computer system of claim 9, wherein the first data transmission unit comprises:
a first switch, selectively coupled to the host unit, the control unit, and a second data transmission unit.

16. The computer system of claim 9, wherein the control unit switches a second data transmission unit to read the backup BIOS code stored in the second storage device via the second data transmission unit after the system power is turned off, and switches the first data transmission unit and the second data transmission unit to restore the read backup BIOS code into the first storage device via the first data transmission unit and the second data transmission unit.

17. The computer system of claim 16, wherein the control unit switches the first data transmission unit and the second data transmission unit to check the BIOS code of the first storage device via the first data transmission unit and the second data transmission unit after the system power is turned off, switches the second data transmission unit to read the backup code stored in the second storage device via the second data transmission unit when an error has occurred in the BIOS code, and switches the second data transmission unit to restore the read backup BIOS code into the first storage device via the first data transmission unit and the second data transmission unit.

18. The computer system of claim 16, wherein the control unit switches the first data transmission unit to connect the first storage device to the host unit after the backup BIOS code is restored into the first storage device, and turns the system power on.

19. The computer system of claim 15, wherein the second data transmission unit comprises:
a second switch, selectively coupled to the first data transmission unit and the second storage device.

20. The computer system of claim 9, wherein the control unit performs a checksum procedure, a parity check procedure, or a cyclic redundancy check procedure on the BIOS code to identify whether an error exists.

21. A method for recovering a basic input/output system (BIOS) in a computer system, the computer system comprising a host unit, a control unit, and a first storage device, the control unit for controlling system power provided to the host unit, the host unit for accessing a BIOS code stored in the first storage device via a first data transmission unit to perform a boot process, the method comprising the steps of:
utilizing the control unit to turn the system power off when the computer system has a recovery requirement;
utilizing the control unit to control the host unit to access data and turn the system power on;
utilizing the host unit to access a BIOS boot block code stored in a second storage device;
utilizing the host unit to execute the BIOS boot block code to restore a backup BIOS code stored in a third storage device into the first storage device;
utilizing the control unit to turn the system power off; and
utilizing the control unit to turn the system power on to make the host unit access the restored BIOS code in the first storage device via the first data transmission unit for performing the boot process.

22. The method of claim 21, wherein the step of utilizing the control unit to turn the system power off when the computer system has the recovery requirement comprises:
utilizing the control unit to turn the system power off when at least one hot key, at least one combination key, or at least one specific button is pressed, or when the control unit checks a number of boot failure occurrences of the computer system is greater than a threshold value.

23. The method of claim 21, wherein the step of utilizing the host unit to access the BIOS boot block code stored in the second storage device comprises:
utilizing the host unit to transmit an access request to the control unit;
utilizing the control unit to read the BIOS boot block code from the second storage device according to the access request; and
utilizing the host unit to access the BIOS boot block code which is read by the control unit.

24. The method of claim 21, wherein the step of utilizing the host unit to execute the BIOS boot block code to restore the backup BIOS code stored in the third storage device into the first storage device comprises:
utilizing the host unit to execute the BIOS boot block code to read the backup BIOS code stored in the third storage device, and restore the backup BIOS code into the first storage device.

25. A computer system, comprising:
a first storage device, for storing a BIOS code;
a second storage device, for storing a control code and a BIOS boot block code;
a third storage device, for storing a backup BIOS code;
a host unit, coupled to the first storage device via a first data transmission unit, for accessing the BIOS code to perform a boot process; and
a control unit, coupled to the host unit, for controlling system power provided to the host unit according to the control code;
wherein when the computer system has a recovery requirement, the host unit accesses the BIOS boot block code, restores the backup BIOS code stored in the third storage device into the first storage device after executing the BIOS boot block code, and accesses the restored BIOS code of the first storage device for the boot process.

26. The computer system of claim. 25, wherein when the computer system has the recovery requirement, the control unit turns the system power off, controls the host unit to access data, and turns the system power on.

27. The computer system of claim 25, wherein when the control unit restores the backup BIOS code into the first storage device, turns the system power off, controls the host unit to access data via the first data transmission unit, and turns the system power on for performing the boot process.

28. The computer system of claim 25 further comprising at least one hot key, at least one combination key, or at least one specific button, wherein when the at least one hot key, the at least one combination key, or the at least one specific button is pressed, the recovery requirement is triggered so that the control unit controls the system power to be turned off according to the recovery requirement.

29. The computer system of claim 25, wherein when the control unit checks a number of boot failure occurrences of the computer system is greater than a threshold value, the control unit turns the system power off.
